(19) United States
(12) Patent Application Publication
(10) Pub. No.: US 2022/0205244 A1
(43) Pub. Date: Jun. 30, 2022

(54) FIBER-REINFORCED COATED MATS AND MAT-FACED PANELS AND METHODS

(71) Applicant: Georgia-Pacific Gypsum LLC, Atlanta, GA (US)

(72) Inventors: Yi-Hsien Harry Teng, Duluth, GA (US); Martin L. Gran, Atlanta, GA (US); Charles E. Diller, Lawrenceville, GA (US); Christopher J. Sanders, Southaven, MS (US); Jeffery T. Fields, Suwanee, GA (US); Mianxue Wu, Suwanee, GA (US)

(21) Appl. No.: 17/697,529

(22) Filed: Mar. 17, 2022

Related U.S. Application Data
(62) Division of application No. 14/629,998, filed on Feb. 24, 2015.
(60) Provisional application No. 61/945,436, filed on Feb. 27, 2014.

(51) Int. Cl. E04C 5/07; E04C 2/04; E04C 2/06; E04C 2/24; B32B 5/18; B32B 13/14; B32B 5/24; B32B 5/02

(52) U.S. Cl. CPC E04C 5/073; E04B 9/045; E04C 2/06; E04C 2/246; E04C 2/243; B32B 5/18; B32B 13/14; B32B 5/245; B32B 5/022; Y10T 428/269; Y10T 428/249953; Y10T 428/31551; Y10T 428/31725; Y10T 428/31739; Y10T 428/31786; Y10T 428/31826; Y10T 428/31935; Y10T 428/31938; Y10T 428/31989; Y10T 442/60; B32B 2264/0242; B32B 2262/02; B32B 2264/025; B32B 2255/02; B32B 2262/0292; B32B 2262/0261; B32B 2264/105; B32B 2262/0269; B32B 2264/0292; B32B 2262/101; B32B 2264/0257; B32B 2255/26; B32B 2262/0276; B32B 2419/04; B32B 2262/0238; B32B 2607/02; B32B 2264/108; B32B 2262/14; B32B 2264/0278; E04C 2/043

(57) ABSTRACT

Fiber-reinforced coated mats and fiber-reinforced coated mat-faced panels are provided herein, along with methods for making the same. Fiber-reinforced coated mats include a mat with a fiber-reinforced coating on one surface. Fiber-reinforced coated mat-faced panels include a fiber-coated mat and a panel material in contact with a surface of the mat opposite the fiber-reinforced coating. Methods include applying a fiber-reinforced coating to a surface of a mat to form a coated mat and drying the coated mat to cure the fiber-reinforced coating. Some methods also include combining the mat with a panel material to form a mat-faced panel.

### CROSS-REFERENCE TO RELATED APPLICATIONS

This application is a divisional application that claims priority to and the benefit of U.S. Nonprovisional application Ser. No. 14/629,998, filed Feb. 24, 2015, which application further claims priority to and the benefit of U.S. Provisional Application No. 61/945,436, filed Feb. 27, 2014; the entire contents of both of which as are hereby incorporated by reference herein.

### FIELD OF THE DISCLOSURE

The present invention relates generally to the field of mat and panels for use in building construction, and more particularly to mats and mat-faced panels having a fiber-reinforced coating.

### BACKGROUND

Wall boards, such as gypsum or foam board panels, are used in building construction to form the partitions or walls of rooms, hallways, ceilings, and the like. Similar boards are also used in exterior wall or roof construction, such as sheathing or roof deck. These panels may include mats, such as fiberglass or other woven or non-woven mats, on one or both faces to enhance the material or performance properties of the board, such as board strength or moisture or mold resistance. For example, these mats may be used in place of traditional paper facings. In addition, fiberglass or other woven or non-woven mats are used by laminating or impregnating with membranes or tiles for roofing, flooring, and ceiling applications,

Accordingly, it would be desirable to provide mats and mat-faced panels having improved properties and methods for producing such improved mats and mat-faced panels and other materials.

### SUMMARY

In one aspect, a method of making a fiber-reinforced coated mat is provided, including applying a fiber-reinforced coating to a first surface of a first mat to form a coated first mat and drying the coated first mat to cure the fiber-reinforced coating.

In another aspect, a method of making a fiber-reinforced coated mat-faced panel is provided, including applying a fiber-reinforced coating to a first surface of a first mat to form a coated first mat, drying the coated first mat to cure the fiber-reinforced coating, and combining the first mat with a panel material to form a mat-faced panel.

In yet another aspect, a fiber-reinforced coated mat is provided, including a first mat having a first surface and a second surface, the first mat having a fiber-reinforced coating on the first surface.

In still yet another aspect, a fiber-reinforced coated mat-faced panel is provided, including a first mat having a first surface and a second surface, the first mat having a fiber-reinforced coating on the first surface, and a panel material in contact with the second surface of the first mat.

### BRIEF DESCRIPTION OF THE DRAWINGS

Referring now to the drawings, which are meant to be exemplary and not limiting, and wherein like elements are numbered alike:

FIG. 1 is a cross-sectional view of a fiber-reinforced coated mat-faced panel.

### DETAILED DESCRIPTION

Disclosed herein are fiber-reinforced coated mats and mat-faced panels and methods for manufacturing such mats and panels. These fiber-reinforced coated mats and panels provide one or more improvements over known mats and mat-faced panels, such as: (i) enhanced mat strength and toughness, (ii) improved mat coating coverage and uniformity, (iii) improved mat surface smoothness and hand feel, (iv) reduced bleeding of panel core materials or adhesives through the mat, (v) decreased water penetration and absorption in panel core materials, (vi) reduced water erosion of panel core material and risk of weathering failure, (vii) improved overall board strength and toughness, (viii) improved surface abrasion resistance, and (ix) enhanced bonding between the mat and the panel core material.

Mats & Panels

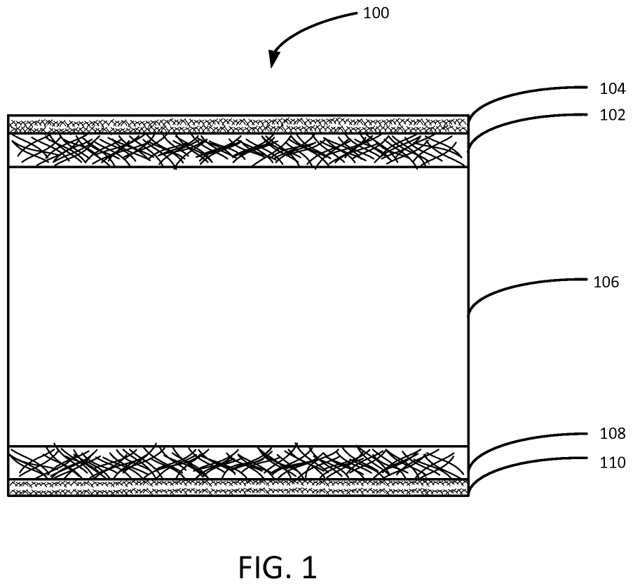

As shown in FIG. 1, in certain embodiments, a fiber-reinforced coated mat-faced panel 100 includes a first mat 102 with a first surface and a second surface, the first mat having a fiber-reinforced coating 104 on the first surface, and a panel material 106 in contact with the second surface of the first mat 102. In certain embodiments, a fiber-reinforced coated mat includes a first mat with a first surface and a second surface, the first mat having a fiber-reinforced coating on the first surface. For example, such a fiber-reinforced coated mat may be combined with a panel material to form the facing material for gypsum, foam, insulation, or cementitious boards, as well as membranes, shingles, underlayments, laminates, flooring membranes or tiles, or ceiling tiles.

In certain embodiments, the panels have a thickness from about ¼ inch to about 1 inch. For example, the panels may have a thickness of about ½ inch, about ⅝ inch, about ¾ inch, or about ⅞ inch. In certain embodiments, the panels may be much thicker than 1 inch.

The panel material, also referred to as a core herein, may be a suitable panel material, such as gypsum or foam. Embodiments of panels disclosed herein may refer to the panel material being gypsum, or a “gypsum core,” though it is to be understood that a foam or other panel material may be substituted for the gypsum material.

For example, a foam core may include polyurethane, polyisocyanurate, polystyrene, phenol resin, magnesium-based cement, or combinations thereof. For example, the gypsum core may be similar to those used in other gypsum products, such as gypsum wallboard, dry wall, gypsum board, gypsum lath, and gypsum sheathing. For example, the gypsum core may be formed by mixing water with powdered anhydrous calcium sulfate or calcium sulfate hemi-hydrate, also known as calcined gypsum, to form an aqueous gypsum slurry, and thereafter allowing the slurry mixture to hydrate or set into calcium sulfate dihydrate, a relatively hard material. The gypsum core may include about 80 weight percent or above of set gypsum (i.e., fully hydrated calcium sulfate). For example, the gypsum core may include about 95 weight percent set gypsum. The gypsum core may also include a variety of additives, such as accelerators, set retarders, foaming agents, and dispersing agents.

In certain embodiments, the core also includes reinforcing fibers, such as chopped glass fibers. For example, a gypsum core may include up to about 1 pound of reinforcing fibers per 100 square feet of panel. For example, a gypsum core may include about 0.3 pounds of reinforcing fibers per 100 square feet of panel. These reinforcing fibers may have a diameter between about 10 and about 17 microns and have a length between about 6.35 and about 12.7 millimeters (¼ to ½ inch).

A core may also include an additive that improves the water-resistant properties of the core. Such additives may include, for example, poly(vinyl alcohol), optionally including a minor amount of poly(vinyl acetate); metallic resinates; wax, asphalt, or mixtures thereof, for example as an emulsion; a mixture of wax and/or asphalt and cornflower and potassium permanganate; water insoluble thermoplastic organic materials such as petroleum and natural asphalt, coal tar, and thermoplastic synthetic resins such as poly(vinyl acetate), poly(vinyl chloride), and a copolymer of vinyl acetate and vinyl chloride, and acrylic resins; a mixture of metal rosin soap, a water soluble alkaline earth metal salt, and residual fuel oil; a mixture of petroleum wax in the form of an emulsion and either residual fuel oil, pine tar, or coal tar; a mixture of residual fuel oil and rosin; aromatic isocyanates and diisocyanates; organopolysiloxanes; siliconates; a wax emulsion and a wax-asphalt emulsion, each optionally with potassium sulfate, alkali, or alkaline earth aluminates, and Portland cement; a wax-asphalt emulsion prepared by adding to a blend of molten wax and asphalt, an oil-soluble, water-dispersing emulsifying agent, and admixing the aforementioned with a solution of case including, as a dispersing agent, an alkali sulfonate of a polyarylmethylene condensation product. Mixtures of these water-resistance additives may also be employed. For example, a mixture of two or more of: poly(vinyl alcohol), siliconates, wax emulsion, and wax-asphalt emulsion of the aforementioned types, may be used to improve the water resistance of the core.

In certain embodiments, the gypsum core has a density from about 130 pounds per 100 square feet to about 300 pounds per 100 square feet. For example, the core may have a density of about 135 pounds per 100 square feet. In certain embodiments, the gypsum core includes a first gypsum layer in contact with the second surface of the first mat and a second gypsum layer having a lower density than the first gypsum layer and in contact with the first gypsum layer and the second surface of the second mat. For example, the first gypsum layer may be a densified gypsum layer having a density about 15 to about 25 percent greater than the density of the second gypsum layer. The gypsum core may also include a third gypsum layer in contact with the second surface of the second mat and the second gypsum layer, which may have a lower density than the first or third gypsum layer. For example, the third gypsum layer may be of the same, higher, or lower density than the first gypsum layer.

In one embodiment, the panel material includes a higher density panel material in contact with the second surface of the first mat and a lower density panel material in contact with the higher density panel material opposite the first mat. In one embodiment, the panel material includes a first layer of a higher density panel material in contact with the second surface of the first mat and a lower density panel material in contact with the first layer of the higher density panel material opposite the first mat, and a second layer of a higher density panel material in contact with the second surface of the second mat and in contact with the lower density panel material opposite the first layer of the higher density panel material.

One or both faces of the panel core material may be faced with a suitable mat. As shown in FIG. 1, in certain embodiments, both surfaces of the panel material 106 are faced with coated fibrous mats 102, 108. The mats 102, 108 are enmeshed or entangled with the panel material 106 at the surface interfaces. That is, while the panel material, mats, and coatings are shown as separate layers in the figure, it should be understood that overlap of these layers occurs at the layer interfaces.

For example, the may be a woven or non-woven fibrous mat. In certain embodiments, the fibrous mat includes glass fibers, carbon fibers, ceramic fibers, polymer fibers, or a combination thereof. For example, the fibers may have a length of at least ¼ inch. In certain embodiments, the mats include a non-woven mat of fiber material that is capable of forming a strong bond with the set gypsum of a gypsum core through a mechanical-like interlocking between the interstices of the fibrous mat and portions of the gypsum core. Examples of fiber materials for use in non-woven mats include inorganic materials such as glass fibers, synthetic resin fibers, and mixtures or blends thereof. Both chopped strands and continuous strands may be used.

In certain embodiments, the mats are non-woven fiberglass mats. For example, the glass fibers may an average diameter from about 9 to about 17 microns and an average length from about ¼ inch to about 1.5 inch. For example, the glass fibers may have an average diameter of 13 microns (i.e., K fibers) and an average length of ¾ inch. In certain embodiments, the non-woven fiberglass mats have a basis weight from about 1.2 pounds to about 3.0 pounds per 100 square feet of the mat. The mats may each have a thickness from about 20 mils to about 26 mils. In certain embodiments, a blend of the above-mentioned fibers and fibers in smaller diameters (<8 microns in nominal) is used in forming the mat. In certain embodiments, the first mat includes a blend of fibers and microfibers. For example, the fibers may have an average diameter from about 9 to about 17 microns and an average length from about ¼ inch to about 1.5 inch, while the microfibers may have a diameter from about 1 to about 6 microns.

In certain embodiments, fibers may be bonded together to form a unitary mat structure by a suitable adhesive binder. For example, the adhesive may be a urea-formaldehyde resin adhesive, optionally modified with a thermoplastic extender or cross-linker, such as an acrylic cross-linker, or an acrylate adhesive resin.

The mats may include a fiber-reinforced coating on one or both mat surfaces. For example, as shown in FIG. 1, the first and second mats 102, 108 may each be coated with a fiber-reinforced coating 104, 110 on the surface of the mat opposite the panel material 106. In one embodiment, the panel includes a second mat having a first surface and a second surface, the second mat comprising a fiber-reinforced coating on the first surface, wherein the second surface of the second mat is in contact with the panel material on a side opposite the first mat. The fiber-reinforced coating may include fibers and a coating base. In one embodiment, the coating base includes resin, latex, or a combination thereof. For example, the coating base may include any suitable adhesive binder material known to those of ordinary skill in the art.

For example, the binder may be an acrylic emulsion, styrene-butadiene-rubber (SBR), styrene-butadiene-styrene (SBS), ethylene-vinyl-chloride (EVCl), poly-vinylidene-chloride (PVdCl) and poly(vinylidene) copolymers, modified poly-vinyl-chloride (PVC), poly-vinyl-alcohol (PVOH), ethylene-vinyl-acetate (EVA), poly-vinyl-acetate (PVA) and polymers and copolymers containing units of acrylic acid, methacrylic acid, their esters and derivatives thereof (acrylic-type polymers), such as styrene-acrylate copolymers. In one embodiment, the binder is a hydrophobic, UV resistant polymer latex binder. For example, the hydrophobic, UV resistant polymer latex binder adhesive may be based on a (meth)acrylate polymer latex, wherein the (meth)acrylate polymer is a lower alkyl ester, such as a methyl, ethyl or butyl ester, of acrylic and/or methacrylic acids, and copolymers of such esters with minor amounts of other ethylenically unsaturated copolymerizable monomers (such as stryrene) which are known to the art to be suitable in the preparation of UV resistant (meth)acrylic polymer latexes.

In one embodiment, the fiber-reinforced coating contains fibers selected from the group consisting of: nylon fibers, polyester fibers, polypropylene fibers, glass fibers, wood cellulose fibers, aramid fibers (such as Kevlar, Nomex, Technora, and Twaron brands), acrylic fibers, polyvinyl chloride fibers, polyolefin fibers, polyurethane fibers, fire resistant or flame retardant polymer fibers, single-crystal calcium sulfate anhydrite whiskers, single-crystal magnesium aluminate whiskers, single-crystal magnesium silicate whiskers, single-crystal calcium silicate whiskers, polyvinyl acetate fibers, and combinations thereof. For example, the fibers may be chopped glass fibers. Moreover, flake-shaped or ribbon-shaped materials, such as die-cut thin films or foils, glitters, chopped ribbons, irregular-shaped thin chips which are metallic, ceramic or polymeric, can be used as reinforcements instead of, or in combination with, the fibers in the fiber-reinforced coating. In one embodiment, the fiber-reinforced coating contains flake-shaped or ribbon-shaped materials selected from the group consisting of: polyester, aluminum, polyvinyl chloride, polyethylene, polypropylene, acrylics, polyurethane, paper, mica, and graphite.

In one embodiment, the fibers are selected from the group consisting of nylon fibers, polyester fibers, polypropylene fibers, glass fibers, wood cellulose fibers, aramid fibers, acrylic fibers, polyvinyl chloride fibers, polyvinyl acetate fibers, polyolefin fibers, polyurethane fibers, fire resistant or flame retardant polymer fibers, single-crystal calcium sulfate anhydrite whiskers, single-crystal magnesium aluminate whiskers, single-crystal magnesium silicate whiskers, single-crystal calcium silicate whiskers, and combinations thereof.

The fibers of the fiber-reinforced coating may have any suitable length and geometry. For example, the fibers may have a nominal length from about 1/16 inch to 1.5 inch, or from about ¼ inch to about ½ inch. For example, the fibers may have a nominal diameter from about 1 micron to about 50 microns, or from about 5 microns to about 25 microns. In one embodiment, the fiber-reinforced coating contains fibers in an amount from about 0.01 weight percent to about 5 weight percent of the coating, on a wet basis. In one embodiment, the fiber-reinforced coating contains fibers in an amount from about 1 weight percent to about 5 weight percent of the coating, on a wet basis. In one embodiment, the fiber-reinforced coating contains fibers in an amount from about 1 weight percent to about 3 weight percent of the coating, on a wet basis. In certain embodiments, the first and/or second mats are fibrous mats having fibers with a longer average length than the fibers of the fiber-reinforced coating. That is, the fiber-reinforced coating may contain short fibers, relative to the fibrous mat(s) to which the coating is applied. The fiber-reinforced coating may also contain fibers having equal or longer lengths than the fibers in the fibrous mat substrate. In one embodiment, the reinforcing fibers have an aspect ratio of at least 10.

The fiber-reinforced coating may also contain water and/or other optional ingredients such as colorants (e.g., dyes or pigments), thickeners or rheological control agents, defoamers, dispersants, fire retardants, biocides, and water repellants. In one embodiment, the fiber-reinforced coating includes pigments, fillers, or combinations thereof. In certain embodiments, colored or painted fibers, flakes, or glitters are used instead of or in combination with pigments or colorants in the fiber-reinforced coatings. The colored glitters can provide special visual or reflectivity effects.

In certain embodiments, the filler of the mat coating is an inorganic, mineral filler. For example, the filler may be ground limestone (calcium carbonate), clay, sand, mica, talc, gypsum (calcium sulfate dihydrate), aluminum trihydrate (ATH), antimony oxide, or any combination thereof. The filler may be in a particulate form. For example, the filler may have a particle size such that at least 95% of the particles pass through a 100 mesh wire screen.

In certain embodiments, the filler may inherently contain a naturally occurring inorganic adhesive binder. For example, the filler may be limestone containing quicklime (CaO), clay containing calcium silicate, sand containing calcium silicate, aluminum trihydrate containing aluminum hydroxide, cementitious fly ash, or magnesium oxide containing either the sulfate or chloride of magnesium, or both. In certain embodiments, the filler may include an inorganic adhesive binder as a constituent, cure by hydration, and act as a flame suppressant. For example, the filler may be aluminum trihydrate (ATH), calcium sulfate (gypsum), and the oxychloride and oxysulfate of magnesium.

Fillers may include inorganic, mineral fillers, such as sodium-potassium alumina silicates, microcrystalline silica, talc (magnesium silicate), and other fillers known to those of ordinary skill in the art. For example, fillers may include MINEX 7, commercially available from the Cary Company (Addison, Ill.); IMSIL A-10, commercially available from the Cary Company; and TALCRON MP 44-26, commercially available from Specialty Minerals Inc. (Dillon, Mont.).

The fiber-reinforced coating may contain any combination of: water, one or more thickeners, one or more surfactants, one or more defoamers, one or more ammonia compositions, one or more fillers, one or more biocide compositions, one or more latex compositions, one or more transfer agents, and one or more UV absorbers.

Thickeners may include hydroxyethyl cellulose; hydrophobically modified ethylene oxide urethane; processed attapulgite, a hydrated magnesium aluminosilicate; and other thickeners known to those of ordinary skill in the art. For example, thickeners may include CELLOSIZE QP-09-L and ACRYSOL RM-2020NPR, commercially available from Dow Chemical Company (Philadelphia, Pa.); and ATTAGEL 50, commercially available from BASF Corporation (Florham Park, N.J.).

Surfactants may include sodium polyacrylate dispersants, ethoxylated nonionic compounds, and other surfactants known to those of ordinary skill in the art. For example, surfactants may include HYDROPALAT 44, commercially available from BASF Corporation; and DYNOL 607, commercially available from Air Products (Allentown, Pa.).

Defoamers may include multi-hydrophobe blend defoamers and other defoamers known to those of ordinary skill in the art. For example, defoamers may include FOAMASTER SA-3, commercially available from BASF Corporation.

Ammonia compositions may include ammonium hydroxide, for example, AQUA AMMONIA 26 BE, commercially available from Tanner Industries, Inc. (Southampton, Pa.).

Biocides may include broad-spectrum microbicides that prohibit bacteria and funig growth, antimicrobials such as those based on the active diiodomethyl-ptolylsulfone, and other compounds known to those of ordinary skill in the art. For example, biocides may include KATHON LX 1.5%, commercially available from Dow Chemical Company, POLYPHASE 663, commercially available from Troy Corporation (Newark, N.J.), and AMICAL Flowable, commercially available from Dow Chemical Company. Biocides may also act as preservatives.

Latex compositions may include acrylic emulsions, self-crosslinking acrylic emulsions, styrene butadiene, polyvinyl acetate, ethylene vinyl acetate, and other latex polymer or co-polymer compounds known to those of ordinary skill in the art, for example, JONCRYL 1987, commercially available from BASF Corporation. In certain embodiments, resinous polymer binders can be used in the fiber-reinforced coatings, such as polyacrylic acid, phenolic resin, urea-formaldehyde, polyvinyl alcohol, and other thermal-set or thermal-plastic resins.

UV absorbers may include encapsulated hydroxyphenyl-triazine compositions and other compounds known to those of ordinary skill in the art, for example, TINUVIN 477DW, commercially available from BASF Corporation.

Transfer agents such as polyvinyl alcohol (PVA) and other compounds known to those of ordinary skill in the art may also be included in the fiber-reinforced coating.

In one embodiment, the fiber-reinforced coating includes about 20% acrylic latex binder, about 3% Kevlar short fiber, about 0.6% inorganic pigment, and about 76% calcium carbonate filler on a dry solid basis. In another embodiment, the fiber-reinforced coating contains about 15% styrene butadiene latex binder, about 2% polyester short fiber, about 2.5% wood cellulose fiber, and about 80% calcium carbonate filler on a dry solid basis. In another embodiment, the fiber-reinforced coating includes about 93% acrylic latex binder, about 2% Kevlar short fiber, 3% gold-colored PET glitter, and about 1.5% ATH flame retardant on a dry solid basis. Percentages used herein are weight percentages, unless otherwise specified.

In certain embodiments, the fiber-reinforced coating has a dry weight from about 5 pounds per thousand square feet to about 100 pounds per thousand square feet of coated mat. For example, the fiber-reinforced coating may have a weight from about 6 pounds per thousand square feet to about 30 pounds per thousand square feet of coated mat. In certain embodiments, the coating slurry contains solids in an amount from about 25 to about 75 weight percent. For example, the coating slurry may contain solids in an amount from about 30 to about 60 weight percent.

The fiber-reinforced coated mat-faced panels may be configured to have certain material properties to keep water, air from permeating the panels. For example, the panel may have a Cobb value below 0.84 grams. In one embodiment, the panel has a Cobb value of 0.5 grams or below. The panel may also have a vapor permeance equal to or greater than 10 perms. The panels may also have additional properties desirable for building materials. For example, the panel may have a class 1 fire rating according to the ASTM E84 standard. The panel may also have a mold growth resistance rating of 10 according to the ASTM D3273 standard.

The fiber-reinforced coating may result in one or more of the following improved mat or panel properties relative to known coated mats and coated mat-faced panels: (i) enhanced mat strength and toughness, (ii) improved mat coating coverage and uniformity, (iii) improved mat surface smoothness and hand feel, (iv) reduced bleeding of panel core materials through the mat, (v) decreased water penetration and absorption in panel core materials, (vi) reduced water erosion of panel core materials and risk of weathering failure, (vii) improved overall board strength and toughness, (viii) improved surface abrasion resistance, and (ix) enhanced bonding between the mat and the panel core material. For example, fiber-reinforced coatings applied to non-woven glass mats tend to penetrate less into the depth of the glass mat, leaving more of the mat open on the uncoated side to allow deeper penetration of the gypsum slurry, thereby enhancing the bond between the coated glass mat and the gypsum core, enhancing finished product strength and toughness. Moreover, deeper penetration of the gypsum slurry into the non-woven glass mat would enhance flexural strengths of the gypsum board panel by providing additional fiber reinforcement to the critical outer regions of the core.

Methods

Methods for making a fiber-reinforced coated mats and coated mat-faced panel are also provided. In certain embodiments, these methods include applying a fiber-reinforced coating to a first surface of a first mat to form a coated first mat and drying the coated first mat to cure the fiber-reinforced coating and form a fiber-reinforced coated mat. In certain embodiments, these methods include: (i) applying a fiber-reinforced coating to a first surface of a first mat to form a coated first mat; (ii) drying the coated first mat to cure the fiber-reinforced coating; and (iii) combining the first mat with a panel material to form a mat-faced panel.

The coated mat is often used a continuous carrier facer on which gypsum slurry or foam liquid is poured to form a continuous core material after curing. The fiber-reinforced coating, panel, and mat may be any embodiment, or combination of embodiments, and include any features described herein. In certain embodiments, a method for making a fiber-reinforced coated mat includes applying a fiber-reinforced coating to a first surface of a first mat to form a coated first mat and drying the coated first mat to cure the fiber-reinforced coating. These fiber-reinforced coated mats may then be combined with a panel material to form the facing material for gypsum, foam, insulation, or cementitious boards, as well as membranes, shingles, underlayments, laminates, flooring membranes or tiles, or ceiling tiles.

The first and/or second mats may be coated or uncoated upon contacting the panel material, such as gypsum slurry. In certain embodiments, both first and second fiberglass mats are pre-coated on the surfaces opposite the gypsum slurry. For example, coated fiberglass mats may be manufactured in a pre-fabricated form. In certain embodiments, the fiber-reinforced coating is applied on the first and/or second mats after they are adhered to the core materials, which is cured afterwards.

In one embodiment, the method includes forming the first mat of fibers in a wet-laid process and drying the first mat comprising fibers, wherein applying the fiber-reinforced coating to the first surface of the first mat comprising fibers occurs prior to drying the first mat comprising fibers. For example, the fiberglass, or other mat fibers, may be wet-formed into a continuous non-woven web of any workable width, coated with the fiber-reinforced coating, and dried to remove excess water and cure the binder to form a fiberglass mat. In one embodiment, the binder in the coating also serves the binder for the glass mat because of migration of liquid binder across the mat. That is, drying the first mat including fibers and drying the coated first mat to cure the fiber-reinforced coating may occur simultaneously.

In one embodiment, the method includes forming the first mat of fibers in a wet-laid process and drying the first mat comprising fibers, wherein applying the fiber-reinforced coating to the first surface of the first mat comprising fibers occurs after drying the first mat comprising fibers. In one embodiment, the method includes applying a binder to the first mat comprising fibers prior to drying the first mat comprising fibers.

For example, forming a mat of fibers in a wet-laid process may include dispersing the fibers in an aqueous solution to form a slurry, and applying the slurry on a wire web to drain the liquid medium and form a non-woven first mat comprising the fibers.

Any suitable method may be used to apply a fiber-reinforced coating to the mat, such as roller coating, curtain coating, knife coating, spray coating and the like, including combinations thereof. For example, the coating may be applied in an amount from about 4 to pounds to about 12 pounds of aqueous coating per 100 square feet of mat. Following application of the aqueous coating to the mat, the composition may be dried to cure the coating, usually by heat to form the coated mat. Thus, coated mats may be provided having a dried, adherent coating applied to one of their surfaces. These mats may be substantially liquid impermeable, but allow water vapor to pass through during manufacturing of the panel.

In certain embodiments, a gypsum, or other panel material, slurry or resinous liquid is applied onto a non-coated surface of a mat as a carrier substrate, i.e., the slurry is applied on a surface of the mat opposite the surface to which the fiber-reinforced coating was applied. In certain embodiments, a gypsum slurry contains excess water (i.e., water in excess of that needed to hydrate the calcined gypsum from which the slurry is made). Reinforcing fibers may also be included in the gypsum slurry. After the panel material slurry is applied onto a second surface of the first mat, the panel material slurry and the first mat are dried to form the mat-faced panel. In certain embodiments, applying the fiber-reinforced coating to the first surface of the first mat occurs after the mat-faced panel is formed, i.e., after the panel material and mat have been combined before or after panel drying. A gypsum sandwich structure (i.e., a gypsum slurry core with one or two mat faces) may be subsequently dried to evaporate the excess water from the gypsum slurry and set the gypsum core.

In one embodiment, the method includes applying a fiber-reinforced coating to a first surface of a second mat to form a coated second mat, drying the coated second mat to cure the fiber-reinforced coating, and combining the second mat with a panel material to form a dual mat-faced panel. In one embodiment, combining the first mat with the panel material includes applying a panel material slurry onto a second surface of the first mat, and combining the second mat with the panel material comprises applying the second mat onto a surface of the panel material slurry opposite the first mat and drying the panel material slurry and the first and second mats to form the dual mat-faced panel. In one embodiment, applying the fiber-reinforced coating to the first surfaces of the first and second mats occurs after the dual mat-faced panel is formed.

The gypsum slurry may be applied on the non-coated side of a horizontally oriented moving web of pre-coated or uncoated mat. A second mat may be applied onto the surface of the slurry opposite the first mat. The mats may both be pre-coated, in which case the surfaces opposite the coated surfaces are contacted to the panel material slurry. For example, another moving web of a mat may be placed on the upper free surface of an aqueous gypsum slurry. The gypsum slurry is sandwiched between the coated fiberglass mats. Using pre-coated fiberglass mats may allow the use of less coating and allow the fiberglass mat to be saturated with a gypsum slurry without excessive bleed through. This saturating helps to insure a maximum bond of the fiberglass mat to the gypsum core.

In certain embodiments, the step of applying the gypsum slurry includes applying a first gypsum slurry onto the surface of the first fiberglass mat, and applying a second gypsum slurry onto the first gypsum slurry, the second gypsum slurry having a lower density than the first gypsum slurry. The step of applying the gypsum slurry may also include applying a third gypsum slurry having greater density than the second slurry onto the surface of the second mat.

In one embodiment, applying the panel material slurry onto the second surface of the first mat includes applying a higher density slurry to the second surface of the first mat and applying a lower density slurry to a surface of the higher density slurry opposite the first mat. In one embodiment, applying the panel material slurry onto the second surface of the first mat includes applying a first layer of a higher density slurry to the second surface of the first mat and applying a lower density slurry to a surface of the first layer of the higher density slurry opposite the first mat, and applying the second mat onto the surface of the panel material slurry opposite the first mat includes applying a second layer of a higher density slurry to a second surface of the second mat and applying the lower density slurry to a surface of the second layer of the higher density slurry opposite the second mat. For example, the higher density slurry may be a slate coat layer. The slate coat layer may be applied to the pre-formed mats prior to application of the lower density panel slurry.

In certain embodiments, the fiber-reinforced coating is applied by spray coating, ribbon coating, knife coating, or direct roll coating the coating on the surface of the mat opposite the gypsum.

Fiber-reinforced coated mat-faced panels may be manufactured on any suitable apparatus known to those of ordinary skill in the art. For example, the apparatus may include a board line for transporting a first mat, a applying mechanism configured to apply a gypsum, or other panel material, slurry onto a surface of the first mat, a conveyor configured to apply a second mat onto a surface of the slurry opposite the first mat, such that a surface of the second mat contacts the slurry. The sandwich structure, i.e., the slurry and two mats, may be transported to a dryer for drying the gypsum sandwich structure, during which the gypsum sets and hardens. For example, the dryer may be an oven operated at a temperature to heat and dry the sandwich structure.

The apparatus may also include a coating applicator, which is configured to apply a fiber-reinforced coating to the surface of the first mat or the second mat opposite the slurry, i.e., the outward-facing surface of the first mat or the second mat. In certain embodiments, the coating applicator is configured to apply the coating to the first mat before the sandwich structure is dried. In some embodiments, applying the coating to the second mat on the top of sandwich is more convenient before the sandwich structure is dried. In alternative embodiments, the coating applicator is configured to apply the coating to the first mat or the second mat after the sandwich structure is dried. In still other embodiments, the coating applicator may be present in an earlier stage of the process, during the mat manufacturing. In these embodiments, the coating applicator may be configured to apply the fiber-reinforced coating before or after drying of the wet mats occurs. For example, the mats may be manufactured from a slurry containing dispersed fibers that is applied on a wire web to drain excess water. Optional additives, such as binders, may be applied to the wet mat, and the fiber-reinforced coating may be applied to a surface of the mat either before or after it is dried.

In certain embodiments, the apparatus includes a transfer mechanism configured to overturn the sandwich structure. In certain embodiments, the apparatus includes a cutting mechanism to cut the continuous sandwich into panels having the desired dimensions. In certain embodiments, a roller or a forming plate compresses the sandwich assembly to the desired thickness. The dry ingredients from which the panel core is formed may be pre-mixed and fed to a mixer, such as a pin mixer. Water and other liquid constituents, such as soap, used in making the core may be metered into the mixer and combined with the desired dry ingredients to form the slurry, (e.g., the aqueous gypsum slurry). Reinforcing fibers may be added to the slurry in the mixer. Foam (e.g., soap) may be added to the slurry in the mixer to control the density of the resulting core and/or gypsum layers. The slurry may be dispersed through one or more outlets from the mixer onto a moving sheet (e.g., non-woven fibrous mat), which is indefinite in length and is fed from a roll thereof onto a board line and advanced by conveyor. Another mat may be fed onto the top of the slurry to form a sandwich structure.

The fiber-reinforced panels disclosed herein may be suitable for use in any applications where mat-faced panels are used, for example in gypsum or other construction boards. Fiber-reinforced coated mat-face panels made by these methods may display one or more of the following improved panel properties relative to known coated mat-faced panels: (i) enhanced mat strength and toughness, (ii) improved mat coating coverage and uniformity, (iii) improved mat surface smoothness and hand feel, (iv) reduced bleeding of panel core materials or adhesives through the mat, (v) decreased water penetration and absorption in panel core materials, (vi) reduced water erosion of panel core material and risk of weathering failure, (vii) improved overall board strength and toughness, (viii) improved surface abrasion resistance, and (ix) enhanced bonding between the mat and the panel core material.

It should be understood that the disclosed fiber-reinforced coatings may be used to coat mats for use as a facing material for gypsum, foam, insulation, and cementitious boards, as well as membranes, shingles, underlayments, laminates, flooring membranes or tiles, and ceiling tiles. The fiber-reinforced coatings disclosed herein may be used to coat woven or non-woven mats, and may contain a fiber or fiber-like material, a binder, and optional additives such as fillers, pigments, dispersants, defoamers, water repellents, thickeners, fire retardants, and flakes. The coating may be applied to a mat formed in a wet-laid process: (i) before drying the mat, such that the coating and mat are cured simultaneously, and then the coated mat may be combined with a board, panel, or membrane, (ii) after drying the mat, so that the coating is cured before the coated mat is combined with the board, panel, or membrane, or (iii) after the mat is combined with the board, panel, or membrane, after which the coating is cured. The fiber-reinforced coating may be applied or laminated to one or both surfaces of a board, panel, or membrane continuously or discontinuously. The fiber-reinforced coated mat may be used as a carrier facer for forming the boards, panels, or membranes continuously or discontinuously.

Embodiments of the present disclosure further include any one or more of the following paragraphs:
1. A method of making a fiber-reinforced coated mat-faced panel, comprising:
   applying a fiber-reinforced coating to a first surface of a first mat to form a coated first mat;
   drying the coated first mat to cure the fiber-reinforced coating; and
   combining the first mat with a panel material to form a mat-faced panel.
2. The method of paragraph 1, wherein the fiber-reinforced coating comprises fibers and a coating base.
3. The method of paragraph 2, wherein the coating base comprises resin, latex, or a combination thereof
4. The method of paragraph 2, wherein the fiber-reinforced coating further comprises pigments, fillers, or combinations thereof
5. The method of paragraph 2, wherein the fibers are selected from the group consisting of:
   nylon fibers, polyester fibers, polypropylene fibers, glass fibers, wood cellulose fibers, aramid fibers, acrylic fibers, polyvinyl chloride fibers, polyvinyl acetate fibers, polyolefin fibers, polyurethane fibers, fire resistant or flame retardant polymer fibers, single-crystal calcium sulfate anhydrite whiskers, single-crystal magnesium aluminate whiskers, single-crystal magnesium silicate whiskers, single-crystal calcium silicate whiskers, and combinations thereof.
6. The method of paragraph 2, wherein the fibers have a nominal length from about 1/16 inch to 1.5 inch, and an aspect ratio at least 10.
7. The method of paragraph 2, wherein the fibers have a nominal length from about ¼ inch to about ½ inch.
8. The method of paragraph 2, wherein the fibers have a nominal diameter from about 1 micron to about 50 microns.
9. The method of paragraph 2, wherein the fibers have a nominal diameter from about 5 microns to about 25 microns.
10. The method of paragraph 2, wherein the fiber-reinforced coating comprises fibers in an amount from about 0.5 weight percent to about 15 weight percent of the coating, on a wet basis.
11. The method of paragraph 2, wherein the fiber-reinforced coating comprises fibers in an amount from about 1 weight percent to about 5 weight percent of the coating, on a wet basis.
12. The method of paragraph 2, wherein the fiber-reinforced coating comprises flake-shaped or ribbon-shaped materials selected from the group consisting of: polyester, aluminum, polyvinyl chloride, polyethylene, polypropylene, acrylics, polyurethane, paper, mica, and graphite.
13. The method of paragraph 1, wherein the first mat comprises a woven or non-woven fibrous mat.
14. The method of paragraph 13, wherein the fibrous mat comprises glass fibers, carbon fibers, ceramic fibers, polymer fibers, or a combination thereof.
15. The method of paragraph 13, wherein the fibrous mat comprises fibers having a nominal length from about ¼ inch to about 1.5 inch.
16. The method of paragraph 2, wherein the first mat comprises a non-woven mat of fibers having a longer average length than the fibers of the fiber-reinforced coating.
17. The method of paragraph 1, further comprising:
   forming the first mat comprising fibers in a wet-laid process; and
   drying the first mat comprising fibers,
   wherein applying the fiber-reinforced coating to the first surface of the first mat comprising fibers occurs prior to drying the first mat comprising fibers.
18. The method of paragraph 17, wherein drying the first mat comprising fibers and drying the fiber-reinforced coating to cure the coated first mat occur simultaneously.
19. The method of paragraph 1, further comprising:
   forming the first mat comprising fibers in a wet-laid process; and
   drying the first mat comprising fibers,
   wherein applying the fiber-reinforced coating to the first surface of the first mat comprising fibers occurs after drying the first mat comprising fibers.
20. The method of paragraph 19, further comprising applying a binder to the first mat comprising fibers prior to drying the first mat comprising fibers.
21. The method of any one of paragraphs 17 or 19, wherein forming the first mat comprising fibers in a wet-laid process comprises:
   dispersing the fibers in an aqueous solution to form a slurry; and
   applying the slurry on a web to drain a liquid medium therefrom and form a non-woven first mat comprising the fibers.
22. The method of paragraph 1, wherein combining the first mat with the panel material comprises:
   applying a panel material slurry onto a second surface of the first mat; and
   drying the panel material and the first mat to form the mat-faced panel.
23. The method of paragraph 22, wherein applying the fiber-reinforced coating to the first surface of the first mat occurs after the mat-faced panel is formed.
24. The method of paragraph 1, wherein the panel material comprises gypsum or foam.
25. The method of paragraph 1, further comprising:
   applying a fiber-reinforced coating to a first surface of a second mat to form a coated second mat;
   drying the coated second mat to cure the fiber-reinforced coating; and
   combining the second mat with a panel material to form a dual mat-faced panel.
26. The method of paragraph 25, wherein:
   combining the first mat with the panel material comprises applying a panel material slurry onto a second surface of the first mat, and
   combining the second mat with the panel material comprises applying the second mat onto a surface of the panel material slurry opposite the first mat and drying the panel material and the first and second mats to form the dual mat-faced panel.
27. The method of paragraph 26, wherein applying the fiber-reinforced coating to the first surfaces of the first and second mats occurs after the dual mat-faced panel is formed.
28. A fiber-reinforced coated mat-faced panel made by the method of any one of paragraphs 1 to 27.
29. A fiber-reinforced coated mat-faced panel, comprising:
   a first mat having a first surface and a second surface, the first mat comprising a fiber-reinforced coating on the first surface; and
   a panel material in contact with the second surface of the first mat.
30. The panel of paragraph 29, wherein the fiber-reinforced coating comprises fibers and a coating base.
31. The panel of paragraph 30, wherein the coating base comprises resin, latex, or a combination thereof.
32. The panel of paragraph 30, wherein the fiber-reinforced coating further comprises pigments, fillers, or a combination thereof.
33. The panel of paragraph 30, wherein the fibers are selected from the group consisting of:
   nylon fibers, polyester fibers, polypropylene fibers, glass fibers, wood cellulose fibers, aramid fibers, acrylic fibers, polyvinyl chloride fibers, polyvinyl acetate fibers, polyolefin fibers, polyurethane fibers, fire resistant or flame retardant polymer fibers, single-crystal calcium sulfate anhydrite whiskers, single-crystal magnesium aluminate whiskers, single-crystal magnesium silicate whiskers, single-crystal calcium silicate whiskers, and combinations thereof.
34. The panel of paragraph 30, wherein the fibers have a nominal length from about 1/16 inch to 1.5 inch, and an aspect ratio at least 10.
35. The panel of paragraph 30, wherein the fibers have a nominal length from about ¼ inch to about ½ inch.
36. The panel of paragraph 30, wherein the fibers have a nominal diameter from about 1 micron to about 50 microns.
37. The panel of paragraph 30, wherein the fibers have a nominal diameter from about 5 microns to about 25 microns.
38. The panel of paragraph 30, wherein the fiber-reinforced coating comprises fibers in an amount from about 0.01 weight percent to about 5 weight percent of the coating, on a wet basis.
39. The panel of paragraph 30, wherein the fiber-reinforced coating comprises fibers in an amount from about 1 weight percent to about 5 weight percent of the coating, on a wet basis.
40. The panel of paragraph 30, wherein the fiber-reinforced coating comprises flake-shaped or ribbon-shaped materials selected from the group consisting of: polyester, aluminum, polyvinyl chloride, polyethylene, polypropylene, acrylics, polyurethane, paper, mica, and graphite.
41. The panel of paragraph 29, wherein the first mat comprises a woven or non-woven fibrous mat.
42. The panel of paragraph 41, wherein the fibrous mat comprises glass fibers, carbon fibers, ceramic fibers, polymer fibers, or a combination thereof.
43. The panel of paragraph 41, wherein the fibrous mat comprises fibers having a nominal length from about ¼ inch to about 1.5 inch.
44. The panel of paragraph 29, wherein the first mat comprises a non-woven mat of fibers having a longer average length than the fibers of the fiber-reinforced coating.
45. The panel of paragraph 29, wherein the panel material comprises gypsum or foam.
46. The panel of paragraph 29, further comprising:
   a second mat having a first surface and a second surface, the second mat comprising a fiber-reinforced coating on the first surface,
   wherein the second surface of the second mat is in contact with the panel material on a side opposite the first mat.
47. The method of paragraph 22, wherein applying the panel material slurry onto the second surface of the first mat comprises applying a higher density slurry to the second surface of the first mat and applying a lower density slurry to a surface of the higher density slurry opposite the first mat.
48. The method of paragraph 26, wherein:
   applying the panel material slurry onto the second surface of the first mat comprises applying a first layer of a higher density slurry to the second surface of the first mat and applying a lower density slurry to a surface of the first layer of the higher density slurry opposite the first mat, and
   applying the second mat onto the surface of the panel material slurry opposite the first mat comprises applying a second layer of a higher density slurry to a second surface of the second mat and applying the lower density slurry to a surface of the second layer of the higher density slurry opposite the second mat.
49. The panel of paragraph 29, wherein the panel material comprises a higher density panel material in contact with the second surface of the first mat and a lower density panel material in contact with the higher density panel material opposite the first mat.
50. The panel of paragraph 46, wherein the panel material comprises:
   a first layer of a higher density panel material in contact with the second surface of the first mat and a lower density panel material in contact with the first layer of the higher density panel material opposite the first mat; and
   a second layer of a higher density panel material in contact with the second surface of the second mat and in contact with the lower density panel material opposite the first layer of the higher density panel material.
51. The method of paragraph 1, wherein the first mat comprises a blend of fibers and microfibers.
52. The panel of paragraph 29, wherein the first mat comprises a blend of fibers and microfibers.
53. A method of making a fiber-reinforced coated mat, comprising:
   applying a fiber-reinforced coating to a first surface of a first mat to form a coated first mat; and
   drying the coated first mat to cure the fiber-reinforced coating.
54. A fiber-reinforced coated mat, comprising:
   a first mat having a first surface and a second surface, the first mat comprising a fiber-reinforced coating on the first surface.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of making a fiber-reinforced coated mat-faced panel, comprising:
forming a first mat comprising fibers in a wet-laid process;
drying the first mat comprising fibers;
after the drying of the first mat comprising fibers, applying a fiber-reinforced coating to a first surface of the first mat comprising fibers to form a coated first mat;
drying the coated first mat to cure the fiber-reinforced coating; and
combining the first mat with a panel material to form a mat-faced panel.

2. The method of claim 1, further comprising, prior to the drying of the first mat comprising fibers, applying an adhesive binder to the first mat comprising fibers.

3. The method of claim 2, wherein the forming of the first mat comprising fibers in the wet-laid process comprises:
dispersing the fibers in an aqueous solution to form a slurry; and
applying the slurry on a web to drain a liquid medium therefrom and form a non-woven first mat comprising the fibers.

4. The method of claim 1, wherein the forming of the first mat comprising fibers in the wet-laid process comprises:
dispersing the fibers in an aqueous solution to form a slurry; and
applying the slurry on a web to drain a liquid medium therefrom and form a non-woven first mat comprising the fibers.

5. The method of claim 1, wherein the combining of the first mat with the panel material comprises:
applying a panel material slurry onto a second surface of the first mat; and
drying the panel material and the first mat to form the mat-faced panel.

6. The method of claim 5, wherein the applying of the fiber-reinforced coating to the first surface occurs after the combining of the first mat with the panel material to form the mat-faced panel.

7. The method of claim 5, wherein the applying of the panel material slurry comprises applying a higher density slurry to the second surface of the first mat and applying a lower density slurry to a surface of the higher density slurry opposite the first mat.

8. The method of claim 1, wherein the applying of the fiber-reinforced coating to the first surface occurs after the combining of the first mat with the panel material to form the mat-faced panel.

9. The method of claim 1, wherein a density of the fiber-reinforced coating is in a range of four (4) to twelve (12) pounds per 100 square feet of the first mat.

10. The method of claim 1, wherein the panel material is either gypsum or foam.

11. The method of claim 1, wherein:
the fiber-reinforced coating comprises fibers and a coating base; and
at least one of:
the coating base comprises one or more of resin or latex;
the fiber-reinforced coating further comprises one or more of pigments or fillers; or
the fiber-reinforced coating comprises fibers in an amount from 0.01 weight percent to 5.0 weight percent of the coating, on a wet basis.

12. The method of claim 11, wherein the first fibrous mat comprises a non-woven mat of fibers having a longer average length than the coating fibers of the fiber-reinforced coating.

13. The method of claim 11, wherein the first mat is a non-woven fibrous mat.

14. The method of claim 13, wherein the first mat includes one or more of glass fibers, carbon fibers, ceramic fibers, or polymer fibers.

15. The method of claim 1, further comprising:
applying a second fiber-reinforced coating to a first surface of a previously dried second mat comprising fibers to form a coated second mat;
drying the coated second mat to cure the second fiber-reinforced coating; and
combining the second mat with the panel material of the mat-faced panel.

16. The method of claim 15, wherein:
the combining of the first mat with the panel material comprises applying a panel material slurry onto a second surface of the first mat; and
the combining of the second mat with the panel material comprises applying the second mat onto a surface of the panel material slurry opposite the first mat.

17. The method of claim 16, wherein the applying of the second fiber-reinforced coating to the first surface of the second mat occurs after the combining of the second met with the panel material of the mat-faced panel.

18. The method of claim 16, wherein the applying of the fiber-reinforced coating to the first surface of the first mat and the applying of the second fiber-reinforced coating to the first surface of the second mat both occur after the combining of the second met with the panel material of the mat-faced panel.

19. The method of claim 16, wherein:
the applying of the panel material slurry onto the second surface of the first mat comprises applying a first layer of a higher density slurry to the second surface of the first mat and applying a lower density slurry to a surface of the first layer of the higher density slurry opposite the first mat; and
the applying of the second mat onto the surface of the panel material slurry opposite the first mat comprises applying a second layer of a higher density slurry to a second surface of the second mat and applying the lower density slurry to a surface of the second layer of the higher density slurry opposite the second mat.

20. The method of claim 15, wherein a structure of the fiber-reinforced coating is different than a structure of the second fiber-reinforced coating.
